(19) United States
(12) Patent Application Publication
(10) Pub. No.: US 2025/0163935 A1
(43) Pub. Date: May 22, 2025

(54) ELECTRIC COMPRESSOR

(71) Applicant: MITSUBISHI HEAVY INDUSTRIES ENGINE & TURBOCHARGER, LTD., Sagamihara-shi, Kanagawa (JP)

(72) Inventors: Tsuyoshi KITAMURA, Tokyo (JP); Byeongil AN, Kanagawa (JP); Makoto OGAWA, Kanagawa (JP); Naomichi SHIBATA, Kanagawa (JP); Hokuto ISODA, Tokyo (JP); Yasutaka AOKI, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 18/841,300

(22) PCT Filed: Feb. 28, 2022
(86) PCT No.: PCT/JP2022/008276

§ 371 Date: Aug. 23, 2024

(51) Int. Cl. F04D 29/58; F04D 17/12; F04D 25/06

(52) U.S. Cl. CPC F04D 29/584; F04D 17/12; F04D 25/06

(57) ABSTRACT

An electric compressor includes: a housing having a stator that has a cylindrical shape; a rotary shaft that is disposed inside the housing and has a rotor facing the stator; a low-pressure stage wheel that is fixed to one side of the rotary shaft in a shaft direction; a high-pressure stage wheel that is fixed to the other side of the rotary shaft in the shaft direction; a motor cooling water passage that is provided on the outside in a radial direction of the stator in the housing; and a wheel side cooling water passage that is provided on at least one of the low-pressure stage side and the high-pressure stage side of the stator in the housing.

### TECHNICAL FIELD

The present disclosure relates to a two-stage compression electric compressor.

### BACKGROUND ART

For example, since a fuel cell requires air having a high pressure, a two-stage compression electric compressor is applied. A two-stage compression electric compressor is configured such that a rotary shaft is rotatably supported by a housing, a low-pressure stage wheel is provided on one side in a shaft direction of the rotary shaft, and a high-pressure stage wheel is provided on the other side in the shaft direction. The rotary shaft is rotatably supported by an air bearing in the housing. A portion of compressed air compressed by the low-pressure stage wheel or the high-pressure stage wheel is bled and supplied to a low-pressure stage side air bearing and a high-pressure stage side air bearing. In addition, the electric compressor rotates a rotor by means of a suction force and a repulsive force of a magnetic force generated by flowing a current to a stator coil constituting a stator, and a rotary shaft integrated with the rotor rotates. Therefore, particularly, the stator (stator coil) is required to be cooled since the stator (stator coil) is at a high temperature. Generally, an electric compressor cools a stator by flowing cooling water into a housing and supplies a portion of compressed air to the stator to cool the stator. As an electric compressor including such an air bearing, for example, there is one described in PTL 1 below.

### CITATION LIST

### Patent Literature [PTL 1] Japanese Patent Application No. 6579649

### SUMMARY OF INVENTION

### Technical Problem

In the electric compressor, a rotary shaft is rotatably supported by an air bearing in a housing. The air bearing needs to be cooled because the air bearing is heated to a high temperature due to heat generation of air. In the related art, the air bearing is cooled by supplying compressed air. Therefore, the amount of compressed air for supply to the air bearing is large, and there is a possibility that a stator will not be sufficiently cooled.

The present disclosure is devised to solve the above-described problems, and an object thereof is to provide an electric compressor that improves cooling performance.

### Solution to Problem

In order to achieve the above-described object, an electric compressor according to the present disclosure includes: a housing having a stator that has a cylindrical shape; a rotary shaft that is disposed inside the housing and that has a rotor facing the stator; a low-pressure stage wheel that is fixed to one side of the rotary shaft in a shaft direction; a high-pressure stage wheel that is fixed to the other side of the rotary shaft in the shaft direction; a motor cooling water passage that is provided on an outer side in a radial direction of the stator in the housing; and a wheel side cooling water passage that is provided on at least one of the low-pressure stage side and the high-pressure stage side of the stator in the housing.

### Advantageous Effects of Invention

According to the electric compressor of the present disclosure, it is possible to improve the cooling performance.

### BRIEF DESCRIPTION OF DRAWINGS

FIG. 1 is a vertical sectional view showing an internal configuration of an electric compressor according to a first embodiment.

FIG. 2 is a vertical sectional view of an electric compressor representing a cooling water passage.

FIG. 3 is a cross-sectional view taken along line III-III of FIG. 2, which shows a motor side cooling water passage.

FIG. 4 is a cross-sectional view taken along line IV-IV of FIG. 2, which shows a high-pressure stage side cooling water passage.

FIG. 5 is a perspective view schematically showing a cooling water passage.

FIG. 6 is a vertical sectional view showing an internal configuration of an electric compressor according to a second embodiment.

FIG. 7 is a cross-sectional view taken along line VII-VII of FIG. 6, which shows a low-pressure stage side cooling water passage.

FIG. 8 is a perspective view schematically showing the cooling water passage.

FIG. 9 is a vertical sectional view showing an internal configuration of an electric compressor according to a third embodiment.

FIG. 10 is a vertical sectional view showing a modification example of the electric compressor of the third embodiment.

FIG. 11 is a perspective view schematically showing a low-pressure stage side cooling water passage in an electric compressor of a fourth embodiment.

### DESCRIPTION OF EMBODIMENTS

Hereinafter, a preferred embodiment of the present disclosure will be described in detail with reference to the drawings. The present disclosure is not limited to the embodiment. In addition, in a case where there are a plurality of embodiments, the present disclosure also includes configurations obtained by combining each embodiment. In addition, constituents in the embodiment include constituents that are easily perceivable by those skilled in the art, constituents that are substantially the same, and constituents within a so-called range of equivalents.

### First Embodiment

### Configuration of Electric Compressor

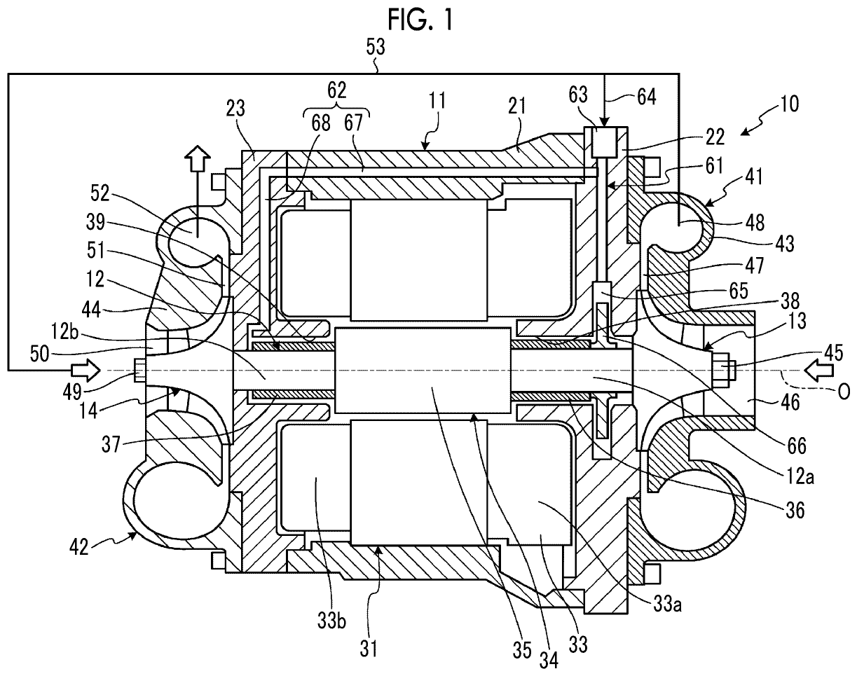

FIG. 1 is a vertical sectional view showing an internal configuration of an electric compressor according to a first embodiment.

As shown in FIG. 1, an electric compressor 10 includes a housing 11, a rotary shaft 12, a low-pressure stage wheel 13, and a high-pressure stage wheel 14.

The housing 11 has a motor housing 21, a low-pressure stage side bearing housing 22, and a high-pressure stage side bearing housing 23. The motor housing 21 has a cylindrical shape, and an end portion on one side in the shaft direction (right side in FIG. 1) has an increased diameter. The low-pressure stage side bearing housing 22 has a disk shape and is disposed on one side in the shaft direction of the motor housing 21. The low-pressure stage side bearing housing 22 is detachably fastened to one end portion of the motor housing 21 in the shaft direction by a plurality of bolts. The high-pressure stage side bearing housing 23 has a disk shape and is disposed on the other side in the shaft direction in the motor housing 21. The high-pressure stage side bearing housing 23 is detachably fastened to the end portion on the other side in the shaft direction of the motor housing 21 by a plurality of bolts.

In the motor housing 21 having a cylindrical shape, one opening in the shaft direction is closed by the low-pressure stage side bearing housing 22, and the other opening in the shaft direction is closed by the high-pressure stage side bearing housing 23. Therefore, the housing 11 has a hollow shape by fastening the low-pressure stage side bearing housing 22 and the high-pressure stage side bearing housing 23 to the motor housing 21.

The stator 31 is fixed to an inner peripheral portion of the motor housing 21. The stator 31 has a cylindrical shape. The stator 31 includes a stator iron core 32 and a stator coil 33. The stator iron core 32 has a cylindrical shape and is fixed such that an outer peripheral surface thereof is in close contact with an inner peripheral surface of the motor housing 21. The stator coil 33 is wound around the stator iron core 32, a part of the stator coil 33 is stored in the stator iron core 32, and a low-pressure stage side coil end 33a and a high-pressure stage side coil end 33b are exposed to one side and the other side of the stator iron core 32 in the shaft direction.

The rotary shaft 12 is disposed inside the housing 11. The rotary shaft 12 is disposed along an axial center O concentric with the housing 11, and is rotatably supported by the housing 11 around the axial center O. A rotor 34 is fixed to an outer peripheral portion of the rotary shaft 12 at an intermediate position in the shaft direction. The rotor 34 has a rotor iron core (permanent magnet) 35. The rotor iron core 35 has a cylindrical shape and is fixed to an outer peripheral surface of the rotary shaft 12.

In the stator 31 and the rotor 34, an inner peripheral surface and an outer peripheral surface face each other in the radial direction. A gap is provided between an inner peripheral surface and an outer peripheral surface of the stator 31 and the rotor 34. Therefore, when a current flows through the stator coil 33 of the stator 31, the rotor 34 rotates due to a suction force and a repulsive force of a magnetic force generated, and the rotary shaft 12 outputs a rotational force.

The rotary shaft 12 is rotatably supported by the housing 11 by a low-pressure stage side air bearing 38 and a high-pressure stage side air bearing 39. The rotary shaft 12 is provided with a low-pressure stage side shaft portion 12a on one side in the shaft direction with respect to the rotor 34, and is provided with a high-pressure stage side shaft portion 12b on the other side in the shaft direction with respect to the rotor 34. The rotary shaft 12 has a low-pressure stage side bearing sleeve 36 mounted on the low-pressure stage side shaft portion 12a to be integrally rotatable therewith, and a high-pressure stage side bearing sleeve 37 mounted on the high-pressure stage side shaft portion 12b to be integrally rotatable therewith. The low-pressure stage side bearing sleeve 36 functions as a low-pressure stage side shaft portion, and the high-pressure stage side bearing sleeve 37 functions as a high-pressure stage side shaft portion. It is to be noted that the low-pressure stage side bearing sleeve 36 and the high-pressure stage side bearing sleeve 37 may not be provided, and the rotary shaft 12 may be directly supported by the low-pressure stage side air bearing 38 and the high-pressure stage side air bearing 39.

The low-pressure stage side air bearing 38 is integrally provided in the low-pressure stage side bearing housing 22. The low-pressure stage side air bearing 38 has a cylindrical shape and is formed to extend from an inner surface of the low-pressure stage side bearing housing 22 to the rotor 34 side. The low-pressure stage side air bearing 38 is disposed on an outer side of the low-pressure stage side bearing sleeve 36 mounted on the rotary shaft 12. In addition, when the rotary shaft 12 is directly supported by the low-pressure stage side air bearing 38, the low-pressure stage side air bearing 38 is disposed on an outer side of the rotary shaft 12. A low-pressure stage side gap is ensured between an inner peripheral surface of the low-pressure stage side air bearing 38 and an outer peripheral surface of the low-pressure stage side bearing sleeve 36.

The high-pressure stage side air bearing 39 is integrally provided in the high-pressure stage side bearing housing 23. The high-pressure stage side air bearing 39 has a cylindrical shape and is formed to extend from an inner surface of the high-pressure stage side bearing housing 23 to the rotor 34 side. The high-pressure stage side air bearing 39 is disposed on an outer side of the high-pressure stage side bearing sleeve 37 mounted on the rotary shaft 12. In addition, when the rotary shaft 12 is directly supported by the high-pressure stage side air bearing 39, the high-pressure stage side air bearing 39 is disposed on the outer side of the rotary shaft 12. A high-pressure stage side gap is ensured between an inner peripheral surface of the high-pressure stage side air bearing 39 and an outer peripheral surface of the high-pressure stage side bearing sleeve 37.

In the housing 11, a low-pressure compressor 41 is disposed on the low-pressure stage side bearing housing 22 side, and a high-pressure compressor 42 is disposed on the high-pressure stage side bearing housing 23 side. The low-pressure compressor 41 includes a low-pressure stage side housing 43 and the low-pressure stage wheel 13. The high-pressure compressor 42 includes a high-pressure stage side housing 44 and the high-pressure stage wheel 14.

The low-pressure stage side housing 43 is fastened to an outer surface of the low-pressure stage side bearing housing 22 by a plurality of bolts. The low-pressure stage wheel 13 is disposed on the inside of the low-pressure stage side housing 43. The low-pressure stage wheel 13 is integrally rotatable and fixed to one end portion of the rotary shaft 12 in the shaft direction by a bolt 45. The low-pressure compressor 41 is provided with an intake port 46, a diffuser 47, a scroll part 48 having a spiral shape, and a discharge port (not shown) by means of the low-pressure stage side housing 43 and the low-pressure stage wheel 13.

The high-pressure stage side housing 44 is fastened to an outer surface of the high-pressure stage side bearing housing 23 by a plurality of bolts. The high-pressure stage wheel 14 is disposed on the inside of the high-pressure stage side housing 44. The high-pressure stage wheel 14 is integrally rotatable and fixed to the other end portion of the rotary shaft 12 in the shaft direction by a bolt 49. The high-pressure compressor 42 is provided with an intake port 50, a diffuser 51, a scroll part 52 having a spiral shape, and a discharge port (not shown) by means of the high-pressure stage side housing 44 and the high-pressure stage wheel 14.

In addition, the discharge port (not shown) and the intake port 50 of the low-pressure compressor 41 and of the high-pressure compressor 42 are connected to each other by a connection passage 53.

In the low-pressure compressor 41, when the low-pressure stage wheel 13 rotates, external air is suctioned from the intake port 46 and is accelerated by a centrifugal force of the low-pressure stage wheel 13, and the accelerated air is decelerated and pressurized by the diffuser 47, and then flows through the scroll part 48 and is discharged from the discharge port. The low-pressure air compressed by the low-pressure compressor 41 is fed to the high-pressure compressor 42 by the connection passage 53. In the high-pressure compressor 42, when the high-pressure stage wheel 14 rotates, the external air is suctioned from the intake port 50 and is accelerated by a centrifugal force of the high-pressure stage wheel 14, and the accelerated air is decelerated and pressurized by the diffuser 51, and then flows through the scroll part 52 and is discharged from the discharge port.

### Air Passages

The electric compressor 10 has a first air passage 61 and a second air passage 62. The first air passage 61 supplies the compressed air from the housing 11 to the low-pressure stage side air bearing 38. The first air passage 61 is provided along the radial direction in the low-pressure stage side bearing housing 22. The first air passage 61 is provided with an air intake port 63 at one end on an outer side in the radial direction. The air intake port 63 is connected to an air bleeding passage 64 branched from the connection passage 53. In the first air passage 61, a portion of the low-pressure air (compressed air) discharged from the low-pressure compressor 41 is bled by the air bleeding passage 64 and supplied to the air intake port 63. In addition, the air intake port 63 may be connected to an air bleeding passage that bleeds the high-pressure air (compressed air) discharged from the high-pressure compressor 42. The low-pressure stage side bearing housing 22 is provided with a low-pressure stage side space portion 65 on an outer peripheral edge of the axial center O. The other end on an inner side in the radial direction of the first air passage 61 communicates with the low-pressure stage side space portion 65.

A thrust disk 66 that constitutes a thrust bearing is fixed to the rotary shaft 12. The thrust disk 66 is fixed between the low-pressure stage side bearing sleeve 36 and the low-pressure stage wheel 13 in the rotary shaft 12. The thrust disk 66 rotates integrally with the rotary shaft 12. The thrust disk 66 is disposed in the low-pressure stage side space portion 65. The low-pressure stage side space portion 65 communicates with a low-pressure stage gap between the inner peripheral surface of the low-pressure stage side air bearing 38 and the outer peripheral surface of the low-pressure stage side bearing sleeve 36.

The compressed air flowing through the first air passage 61 is supplied to the low-pressure stage side space portion 65 to cool a support surface (one surface and the other surface in the shaft direction in the low-pressure stage side space portion 65) that supports the thrust disk 66. Then, the compressed air in the low-pressure stage side space portion 65 is supplied to the low-pressure stage side air bearing 38. That is, the compressed air is supplied to the low-pressure stage gap between the inner peripheral surface of the low-pressure stage side air bearing 38 and the outer peripheral surface of the low-pressure stage side bearing sleeve 36 to support the rotary shaft 12 at a predetermined position in the radial direction. Thereafter, the compressed air supplied to the low-pressure stage side air bearing 38 is discharged to the outside from a discharge port (not shown) provided in the housing 11.

The second air passage 62 is provided to be branched from the first air passage 61, and supplies the compressed air to the high-pressure stage side air bearing 39. The second air passage 62 has a shaft direction air passage 67 and a radial direction air passage 68. The shaft direction air passage 67 is branched from the first air passage 61 and is provided along the shaft direction of the rotary shaft 12 in the motor housing 21. The radial direction air passage 68 is provided along the radial direction of the rotary shaft 12 in the high-pressure stage side bearing housing 23 to communicate with the shaft direction air passage 67. The radial direction air passage 68 communicates with a high-pressure stage gap between the inner peripheral surface of the high-pressure stage side air bearing 39 and the outer peripheral surface of the high-pressure stage side bearing sleeve 37.

The compressed air branched from the first air passage 61 flows in the shaft direction through the shaft direction air passage 67 of the second air passage 62, then flows inward in the radial direction through the radial direction air passage 68 and is supplied to the high-pressure stage side air bearing 39. That is, the compressed air is supplied to the high-pressure stage gap between the inner peripheral surface of the high-pressure stage side air bearing 39 and the outer peripheral surface of the high-pressure stage side bearing sleeve 37 to support the rotary shaft 12 at a predetermined position in the radial direction. Thereafter, the compressed air supplied to the high-pressure stage side air bearing 39 flows into a gap between the stator 31 and the rotor 34 to cool the stator iron core 32 and the stator coil 33 of the stator 31. The compressed air for cooling the stator 31 is discharged to the outside from a discharge port (not shown) provided in the housing 11.

### Motor Cooling Water Passage

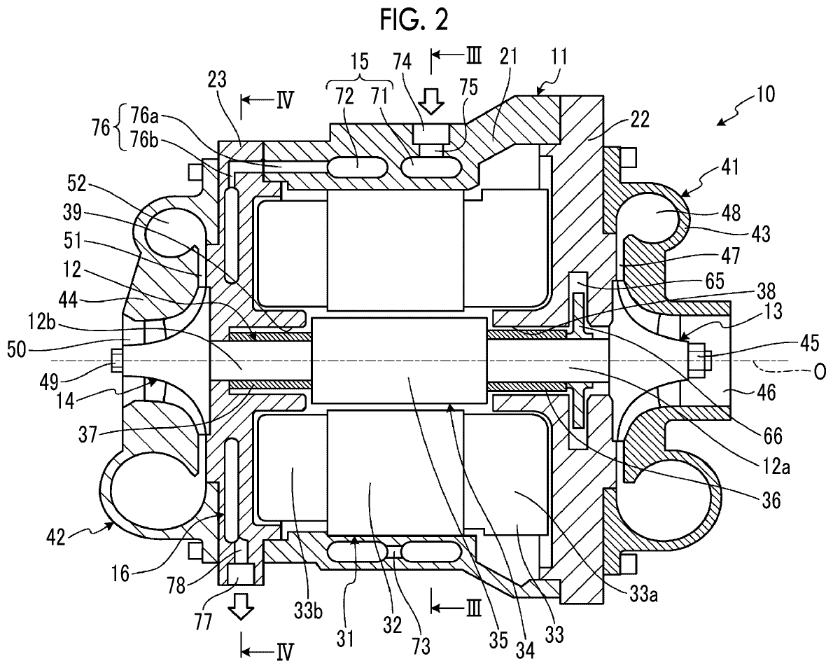

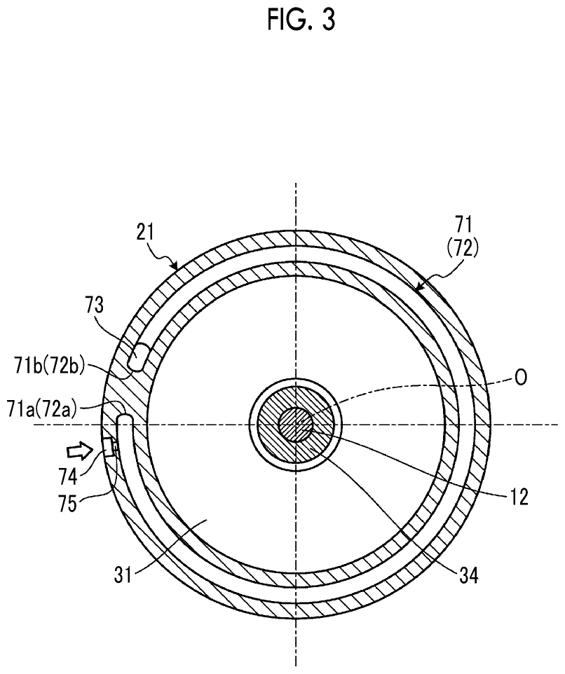

FIG. 2 is a vertical sectional view of an electric compressor representing a cooling water passage, and FIG. 3 is a cross-sectional view taken along line III-III of FIG. 2 representing a first cooling water passage.

As shown in FIGS. 2 and 3, the electric compressor 10 includes the housing 11, the rotary shaft 12, the low-pressure stage wheel 13, and the high-pressure stage wheel 14, and further includes a motor cooling water passage 15 and a high-pressure stage side cooling water passage (wheel side cooling water passage) 16.

The motor cooling water passage 15 is provided on an outer side of the stator 31 in the housing 11. The motor cooling water passage 15 has a low-pressure stage side motor cooling water passage 71 and a high-pressure stage side motor cooling water passage 72.

The low-pressure stage side motor cooling water passage 71 is provided on the low-pressure stage wheel 13 side on an outer side of the stator iron core 32 in the radial direction in the motor housing 21. The high-pressure stage side motor cooling water passage 72 is provided on the high-pressure stage wheel 14 side on the outer side of the stator iron core 32 in the radial direction in the motor housing 21. The low-pressure stage side motor cooling water passage 71 and the high-pressure stage side motor cooling water passage 72 are discontinuous in the circumferential direction of the stator 31. That is, the low-pressure stage side motor cooling water passage 71 is formed along the circumferential direction of the motor housing 21, a first end portion 71a is provided on one side in the circumferential direction, and a second end portion 71b is provided on the other side in the circumferential direction. In addition, the high-pressure stage side motor cooling water passage 72 is formed along the circumferential direction of the motor housing 21, and a first end portion 72a is provided on one side in the circumferential direction, and a second end portion 72b is provided on the other side in the circumferential direction.

The low-pressure stage side motor cooling water passage 71 and the high-pressure stage side motor cooling water passage 72 are provided at intervals in the shaft direction of the stator 31. In the low-pressure stage side motor cooling water passage 71 and the high-pressure stage side motor cooling water passage 72, the second end portion 71b and the second end portion 72b communicate with each other via a motor side connecting portion 73. The motor side connecting portion 73 is provided along the shaft direction of the stator 31, one end is connected to the second end portion 71b of the low-pressure stage side motor cooling water passage 71, and the other end is connected to the second end portion 72b of the high-pressure stage side motor cooling water passage 72.

The motor housing 21 is provided with a cooling water inlet portion 74 in an outer peripheral portion. The cooling water inlet portion 74 is connected to the first end portion 71a of the low-pressure stage side motor cooling water passage 71 by an inlet connecting portion 75. In addition, the high-pressure stage side motor cooling water passage 72 is connected to the high-pressure stage side cooling water passage 16 by a coil side connecting portion (low-pressure coil side connecting portion) 76 at the first end portion 72a. The coil side connecting portion 76 has a shaft direction connecting portion 76a and a radial direction connecting portion 76b. The shaft direction connecting portion 76a is formed in the motor housing 21 and the high-pressure stage side bearing housing 23, and the radial direction connecting portion 76b is formed in the high-pressure stage side bearing housing 23. In the high-pressure stage side motor cooling water passage 72, an end portion of the shaft direction connecting portion 76a of the coil side connecting portion 76 is connected to the second end portion 72b.

### High-Pressure Stage Side Cooling Water Passage

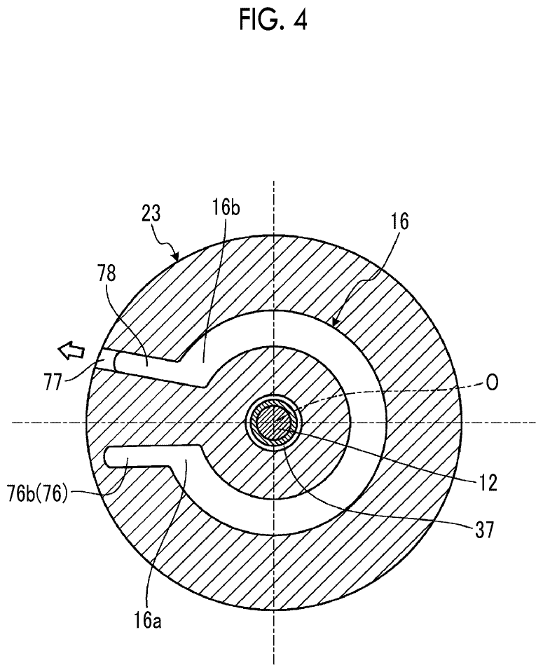

FIG. 4 is a cross-sectional view taken along line IV-IV of FIG. 2, which shows a high-pressure stage side cooling water passage.

As shown in FIGS. 2 and 4, the high-pressure stage side cooling water passage 16 is provided on the high-pressure stage wheel 14 side of the stator 31 in the housing 11.

The high-pressure stage side cooling water passage 16 is provided on the high-pressure stage wheel 14 side on an outer side of the high-pressure stage side coil end 33b of the stator coil 33 in the shaft direction in the high-pressure stage side bearing housing 23. The high-pressure stage side cooling water passage 16 is discontinuous in the circumferential direction of the stator 31. That is, the high-pressure stage side cooling water passage 16 is formed along the circumferential direction of the high-pressure stage side bearing housing 23, and a first end portion 16a is provided on one side in the circumferential direction, and a second end portion 16b is provided on the other side in the circumferential direction.

The high-pressure stage side cooling water passage 16 is connected to the high-pressure stage side motor cooling water passage 72 by the coil side connecting portion 76. In the high-pressure stage side cooling water passage 16, an end portion of the radial direction connecting portion 76b of the coil side connecting portion 76 is connected to the first end portion 16a. In addition, the high-pressure stage side bearing housing 23 is provided with a cooling water outlet portion 77 in an outer peripheral portion. The cooling water outlet portion 77 is connected to the second end portion 16b of the high-pressure stage side cooling water passage 16 by an outlet connecting portion 78.

### Entire Configuration of Cooling Water Passage

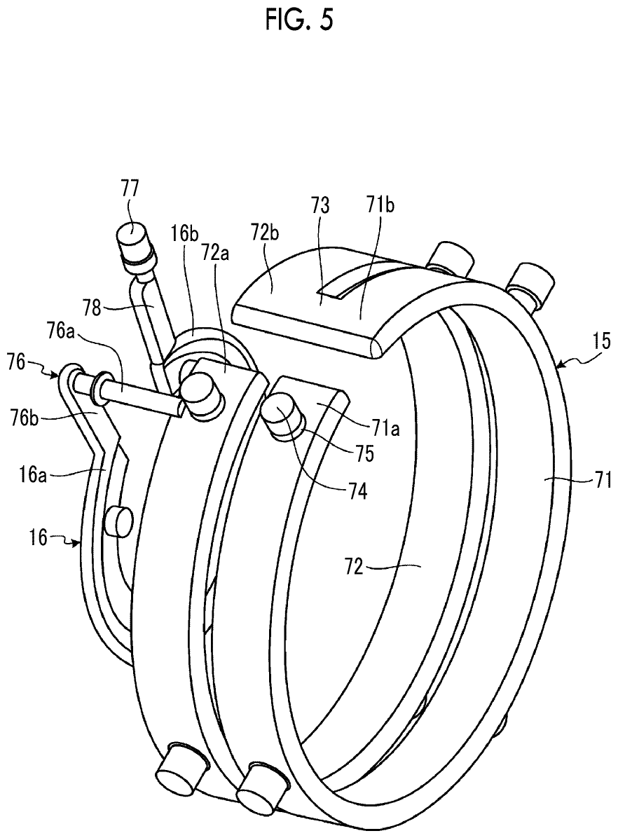

FIG. 5 is a perspective view schematically showing a cooling water passage.

As shown in FIGS. 1 and 5, the low-pressure stage side motor cooling water passage 71 and the high-pressure stage side motor cooling water passage 72 serving as the motor cooling water passages 15 are disposed along the circumferential direction at intervals in the shaft direction. In the low-pressure stage side motor cooling water passage 71 and the high-pressure stage side motor cooling water passage 72, the second end portion 71b and the second end portion 72b are connected to each other by the motor side connecting portion 73. In the low-pressure stage side motor cooling water passage 71, the cooling water inlet portion 74 is connected to the first end portion 71a via the inlet connecting portion 75. The high-pressure stage side cooling water passage 16 is connected to the high-pressure stage side motor cooling water passage 72 by the coil side connecting portion 76.

The high-pressure stage side cooling water passage 16 is disposed along the circumferential direction and is disposed at an interval from the high-pressure stage side motor cooling water passage 72 in the shaft direction. In the coil side connecting portion 76, the shaft direction connecting portion 76a is connected to the first end portion 72a of the high-pressure stage side motor cooling water passage 72, and the radial direction connecting portion 76b is connected to the first end portion 16a of the high-pressure stage side cooling water passage 16. The high-pressure stage side cooling water passage 16 is provided with the cooling water outlet portion 77 at the second end portion 16b via the outlet connecting portion 78. In addition, a part of the passage may be extracted and connected to the outside, depending on the form of the electric compressor 10.

The cooling water is supplied to the cooling water inlet portion 74 provided in the housing 11 and is supplied to the low-pressure stage side motor cooling water passage 71 of the motor cooling water passage 15 via the inlet connecting portion 75. The cooling water supplied to the low-pressure stage side motor cooling water passage 71 flows in the circumferential direction, is supplied to the high-pressure stage side motor cooling water passage 72 by the motor side connecting portion 73, and flows in the circumferential direction. At this time, the stator iron core 32 in the stator 31 is cooled by the cooling water flowing inside the motor housing 21.

The cooling water flowing through the high-pressure stage side motor cooling water passage 72 in the circumferential direction is supplied to the high-pressure stage side cooling water passage 16 by the coil side connecting portion 76. The cooling water supplied to the high-pressure stage side cooling water passage 16 flows in the circumferential direction. At this time, the high-pressure stage side air bearing 39 is cooled by the cooling water flowing inside the high-pressure stage side bearing housing 23. The cooling water flowing in the high-pressure stage side cooling water passage 16 in the circumferential direction is discharged to the outside from the cooling water outlet portion 77 via the outlet connecting portion 78.

### Operation of Electric Compressor

As shown in FIGS. 1 and 2, the electric compressor 10 causes the rotor 34 to rotate by flowing a current to the stator coil 33 constituting the stator 31, and the rotor 34 and the integrated rotary shaft 12 rotate. The rotary shaft 12 has the low-pressure stage wheel 13 and the high-pressure stage wheel 14 connected to each end portion. Therefore, in particular, the stator 31 becomes high in temperature. The electric compressor 10 of the first embodiment is of an air cooling type and a water cooling type. That is, the electric compressor 10 bleeds a portion of the compressed air compressed by the low-pressure stage wheel 13, supplies the bled portion to the low-pressure stage side air bearing 38 and the high-pressure stage side air bearing 39, and then supplies the portion to the stator 31 to cool the stator 31. In addition, the electric compressor 10 supplies cooling water from the outside to the motor cooling water passage 15 to cool the stator iron core 32 of the stator 31. Then, the electric compressor 10 supplies the cooling water of the motor cooling water passage 15 to the high-pressure stage side cooling water passage 16 to cool the high-pressure stage side air bearing 39.

In the electric compressor 10, the high-pressure stage side air bearing 39 is appropriately cooled by the cooling water. In addition, the stator 31 and the rotor 34 of the electric compressor 10 are appropriately cooled by the compressed air. That is, since the high-pressure stage side air bearing 39 is appropriately cooled by the cooling water, the flow rate of the compressed air for cooling the high-pressure stage side air bearing 39 can be reduced. Therefore, by using the compressed air mainly for the stator 31 and the rotor 34, air shortage in the stator 31 and the rotor 34 can be suppressed, and the stator 31 and the rotor 34 can be appropriately cooled.

In the above description, the cooling water inlet portion 74 is connected to the motor cooling water passage 15 via the inlet connecting portion 75, and the cooling water outlet portion 77 is connected to the high-pressure stage side cooling water passage 16 via the outlet connecting portion 78. However, the present disclosure is not limited to this configuration. For example, the cooling water outlet portion 77 may be connected to the motor cooling water passage 15 via the outlet connecting portion 78, and the cooling water inlet portion 74 may be connected to the high-pressure stage side cooling water passage 16 via the inlet connecting portion 75.

In addition, the low-pressure stage side motor cooling water passage 71 and the high-pressure stage side motor cooling water passage 72 are connected to each other by the motor side connecting portion 73. However, the present disclosure is not limited to this configuration. For example, the low-pressure stage side motor cooling water passage 71 and the high-pressure stage side motor cooling water passage 72 may be provided independently, and the cooling water inlet portion 74 or the cooling water outlet portion 77 may be provided in each of the low-pressure stage side motor cooling water passage 71 and the high-pressure stage side motor cooling water passage 72.

### Second Embodiment

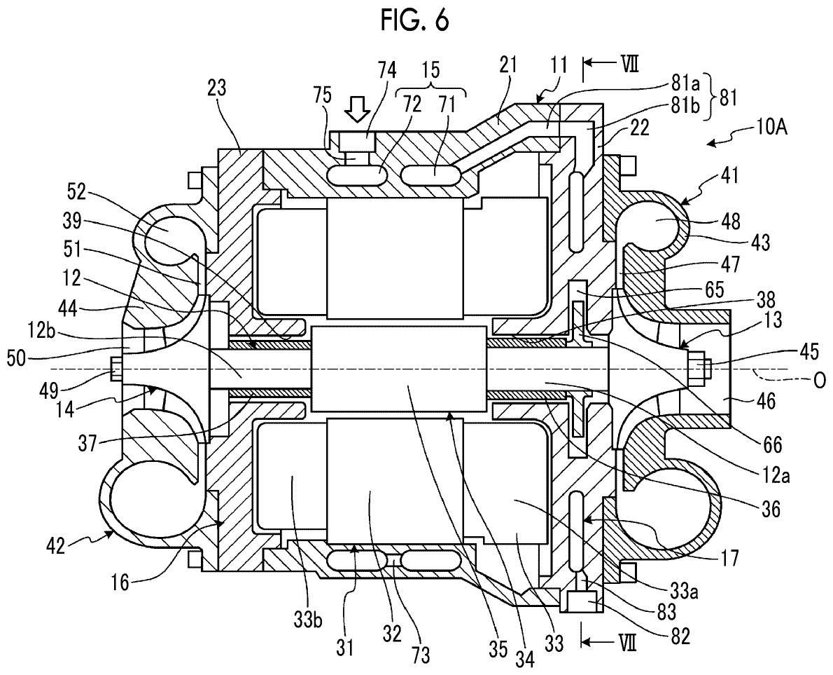

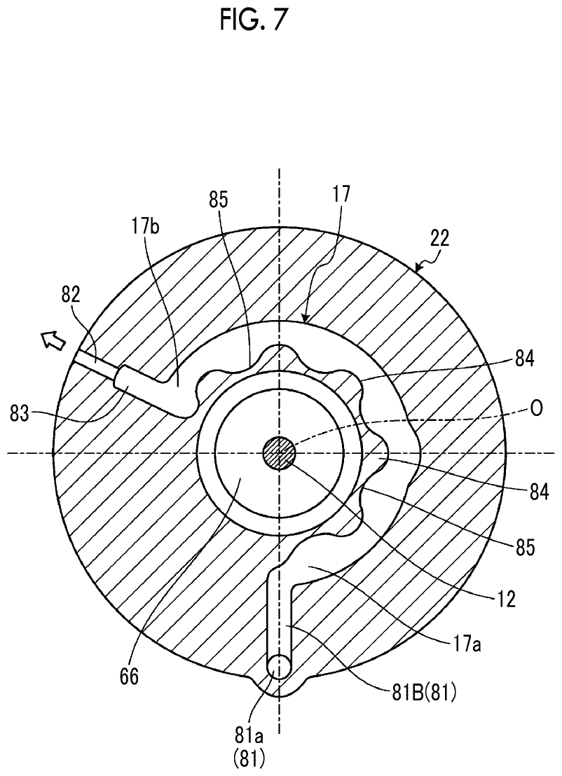

FIG. 6 is a vertical sectional view showing an internal configuration of an electric compressor of a second embodiment, and FIG. 7 is a cross-sectional view taken along line VII-VII of FIG. 6, which shows the low-pressure stage side cooling water passage. The same reference numerals will be given to the members having the same functions as the members in the first embodiment described above, and the detailed description thereof will be omitted.

As shown in FIG. 6, an electric compressor 10A includes the housing 11, the rotary shaft 12, the low-pressure stage wheel 13, the high-pressure stage wheel 14, the motor cooling water passage 15, and a low-pressure stage side cooling water passage (wheel side cooling water passage) 17. Here, the housing 11, the rotary shaft 12, the low-pressure stage wheel 13, the high-pressure stage wheel 14, and the motor cooling water passage 15 are the same as those in the first embodiment.

As shown in FIGS. 6 and 7, the motor cooling water passage 15 has the low-pressure stage side motor cooling water passage 71 and the high-pressure stage side motor cooling water passage 72. The low-pressure stage side motor cooling water passage 71 and the high-pressure stage side motor cooling water passage 72 are discontinuous in the circumferential direction of the stator 31. In the low-pressure stage side motor cooling water passage 71 and the high-pressure stage side motor cooling water passage 72, the second end portion 71b and the second end portion 72b communicate with each other via the motor side connecting portion 73.

The motor housing 21 is provided with a cooling water inlet portion 74 in an outer peripheral portion. The cooling water inlet portion 74 is connected to the first end portion 72a of the high-pressure stage side motor cooling water passage 72 by the inlet connecting portion 75. In addition, the low-pressure stage side motor cooling water passage 71 is connected to the low-pressure stage side cooling water passage 17 by a coil side connecting portion (high-pressure coil side connecting portion) 81 at the second end portion 71b. The coil side connecting portion 81 has a shaft direction connecting portion 81a and a radial direction connecting portion 81b. The shaft direction connecting portion 81a is formed in the motor housing 21 and the low-pressure stage side bearing housing 22, and the radial direction connecting portion 81b is formed in the low-pressure stage side bearing housing 22. In the low-pressure stage side motor cooling water passage 71, an end portion of the shaft direction connecting portion 81a of the coil side connecting portion 81 is connected to the second end portion 71b.

The low-pressure stage side cooling water passage 17 is provided on the low-pressure stage wheel 13 side of the stator 31 in the housing 11.

The low-pressure stage side cooling water passage 17 is provided on the low-pressure stage wheel 13 side on an outer side of the low-pressure stage side coil end 33a of the stator coil 33 in the shaft direction in the low-pressure stage side bearing housing 22. The low-pressure stage side cooling water passage 17 is discontinuous in the circumferential direction of the stator 31. That is, the low-pressure stage side cooling water passage 17 is formed along the circumferential direction of the low-pressure stage side bearing housing 22, and the first end portion 17a is provided on one side in the circumferential direction, and the second end portion 17b is provided on the other side in the circumferential direction.

The low-pressure stage side cooling water passage 17 is connected to the low-pressure stage side motor cooling water passage 71 by the coil side connecting portion 81. In the low-pressure stage side cooling water passage 17, an end portion of the radial direction connecting portion 81b of the coil side connecting portion 81 is connected to the first end portion 17a. In addition, the low-pressure stage side bearing housing 22 is provided with a cooling water outlet portion 82 in an outer peripheral portion. The cooling water outlet portion 82 is connected to the second end portion 17b of the low-pressure stage side cooling water passage 17 by an outlet connecting portion 83.

In addition, a passage area of the low-pressure stage side cooling water passage 17 varies in the circumferential direction. That is, an outer peripheral surface of the low-pressure stage side cooling water passage 17 is an arc centered on the axial center O. Meanwhile, the low-pressure stage side cooling water passage 17 has an inner peripheral surface having an undulating shape in which a protrusion 84 protruding outward in the radial direction and a recess 85 recessed inward in the radial direction are alternately provided in the circumferential direction with respect to an arc centered on the axial center O. Here, the recess 85 is a region through which a bolt (not shown) for fastening the motor housing 21 and the low-pressure stage side bearing housing 22 is inserted. Therefore, in the low-pressure stage side cooling water passage 17, the protrusions 84 and the recesses 85 are alternately provided in the circumferential direction on the inner peripheral surface, and accordingly, the passage area varies along the circumferential direction.

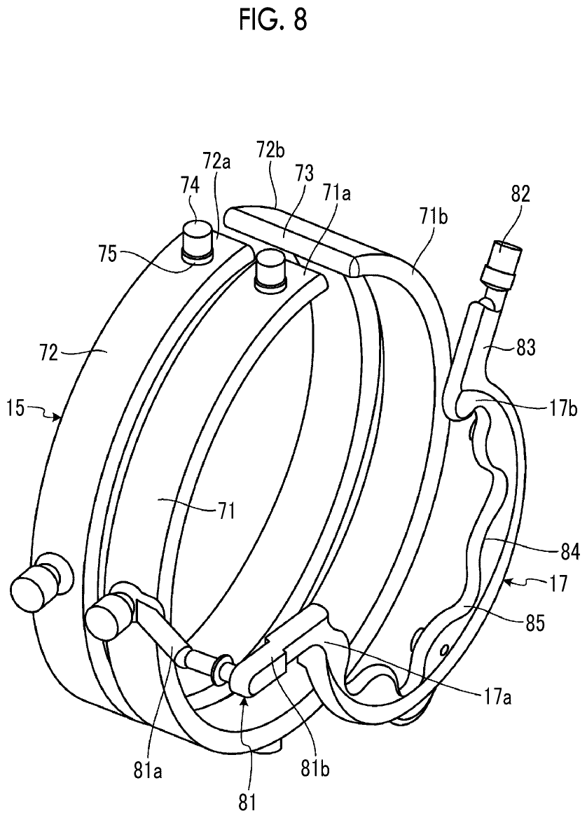

FIG. 8 is a perspective view schematically showing the cooling water passage.

As shown in FIGS. 6 and 8, the low-pressure stage side motor cooling water passage 71 and the high-pressure stage side motor cooling water passage 72 as the motor cooling water passages 15 are disposed along the circumferential direction at intervals in the shaft direction. In the low-pressure stage side motor cooling water passage 71 and the high-pressure stage side motor cooling water passage 72, the second end portion 71b and the second end portion 72b are connected to each other by the motor side connecting portion 73. In the high-pressure stage side motor cooling water passage 72, the cooling water inlet portion 74 is connected to the first end portion 72a via the inlet connecting portion 75. The low-pressure stage side cooling water passage 17 is connected to the low-pressure stage side motor cooling water passage 71 by the coil side connecting portion 81.

The low-pressure stage side cooling water passage 17 is disposed along the circumferential direction and is disposed at an interval from the low-pressure stage side motor cooling water passage 71 in the shaft direction. In the coil side connecting portion 81, the shaft direction connecting portion 81a is connected to the low-pressure stage side motor cooling water passage 71, and the radial direction connecting portion 81b is connected to the first end portion 17a of the low-pressure stage side cooling water passage 17. The shaft direction connecting portion 81a in the coil side connecting portion 81 may be connected to the first end portion 71a of the low-pressure stage side motor cooling water passage 71. The low-pressure stage side cooling water passage 17 is provided with the cooling water outlet portion 82 at the second end portion 17b via the outlet connecting portion 83.

The cooling water is supplied to the cooling water inlet portion 74 provided in the housing 11 and is supplied to the high-pressure stage side motor cooling water passage 72 of the motor cooling water passage 15 via the inlet connecting portion 75. The cooling water supplied to the high-pressure stage side motor cooling water passage 72 flows in the circumferential direction, is supplied to the low-pressure stage side motor cooling water passage 71 by the motor side connecting portion 73, and flows in the circumferential direction. At this time, the stator iron core 32 in the stator 31 is cooled by the cooling water flowing inside the motor housing 21.

The cooling water flowing through the low-pressure stage side motor cooling water passage 71 in the circumferential direction is supplied to the low-pressure stage side cooling water passage 17 by the coil side connecting portion 81. The cooling water supplied to the low-pressure stage side cooling water passage 17 flows in the circumferential direction. At this time, the low-pressure stage side air bearing 38 is cooled by the cooling water flowing inside the low-pressure stage side bearing housing 22. Then, the cooling water flows through the low-pressure stage side cooling water passage 17 in which the protrusions 84 and the recesses 85 are alternately provided in the circumferential direction on the inner peripheral surface, and accordingly, a contact area between the cooling water and an inner surface of the low-pressure stage side cooling water passage 17 increases, and cooling performance of the low-pressure stage side bearing housing 22 by the cooling water is improved. The cooling water flowing through the low-pressure stage side cooling water passage 17 in the circumferential direction is discharged to the outside from the cooling water outlet portion 82 via the outlet connecting portion 83.

The electric compressor 10A bleeds a portion of the compressed air compressed by the low-pressure stage wheel 13, supplies the bled portion to the low-pressure stage side air bearing 38 and the high-pressure stage side air bearing 39, and then supplies the bled portion to a gap between the stator 31 and the rotor 34 for cooling. In addition, the electric compressor 10A supplies cooling water from the outside to the motor cooling water passage 15 to cool the low-pressure stage side air bearing 38.

In the electric compressor 10A, the low-pressure stage side air bearing 38 is appropriately cooled by the cooling water. In addition, the stator 31 and the rotor 34 of the electric compressor 10A are appropriately cooled by the compressed air. That is, since the low-pressure stage side air bearing 38 is appropriately cooled by the cooling water, the flow rate of the compressed air for cooling the low-pressure stage side air bearing 38 can be reduced. Therefore, by using the compressed air mainly for the stator 31 and the rotor 34, air shortage in the stator 31 and the rotor 34 can be suppressed, and the stator 31 and the rotor 34 can be appropriately cooled.

In the above description, the cooling water inlet portion 74 is connected to the motor cooling water passage 15 via the inlet connecting portion 75, and the cooling water outlet portion 82 is connected to the low-pressure stage side cooling water passage 17 via the outlet connecting portion 83. However, the present disclosure is not limited to this configuration. For example, the cooling water outlet portion 82 may be connected to the motor cooling water passage 15 via the outlet connecting portion 83, and the cooling water inlet portion 74 may be connected to the low-pressure stage side cooling water passage 17 via the inlet connecting portion 75.

### Third Embodiment

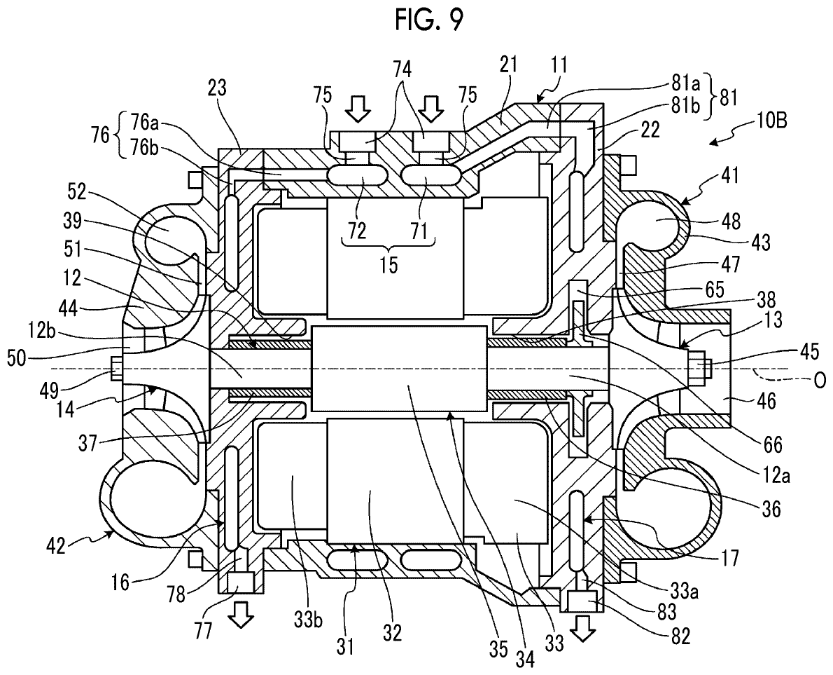

FIG. 9 is a vertical sectional view showing an internal configuration of an electric compressor according to a third embodiment. The same reference numerals will be given to the members having the same functions as the members in the first embodiment described above, and the detailed description thereof will be omitted.

As shown in FIG. 9, an electric compressor 10B includes the housing 11, the rotary shaft 12, the low-pressure stage wheel 13, the high-pressure stage wheel 14, the motor cooling water passage 15, the high-pressure stage side cooling water passage 16, and the low-pressure stage side cooling water passage 17. Here, the housing 11, the rotary shaft 12, the low-pressure stage wheel 13, the high-pressure stage wheel 14, and the motor cooling water passage 15 are the same as those in the first embodiment and the second embodiment. In addition, the high-pressure stage side cooling water passage 16 is the same as that in the first embodiment, and the low-pressure stage side cooling water passage 17 is the same as that in the second embodiment.

That is, the electric compressor 10B is provided with the low-pressure stage side motor cooling water passage 71 and the high-pressure stage side motor cooling water passage 72 as the motor cooling water passage 15 in the motor housing 21. In the electric compressor 10B, the high-pressure stage side cooling water passage 16 is provided in the high-pressure stage side bearing housing 23, and the low-pressure stage side cooling water passage 17 is provided in the low-pressure stage side bearing housing 22.

The cooling water is supplied from a cooling water inlet portion 74 on the high-pressure stage side to the high-pressure stage side motor cooling water passage 72 and flows in the circumferential direction. In addition, the cooling water is supplied from a cooling water inlet portion 74 on the low-pressure stage side to the low-pressure stage side motor cooling water passage 71 and flows in the circumferential direction. At this time, the stator iron core 32 in the stator 31 is cooled by the cooling water flowing inside the motor housing 21.

The cooling water flowing in the circumferential direction in the high-pressure stage side motor cooling water passage 72 is supplied to the high-pressure stage side cooling water passage 16 by the coil side connecting portion 76 and flows in the circumferential direction. At this time, the high-pressure stage side air bearing 39 is cooled by the cooling water flowing inside the high-pressure stage side bearing housing 23. On the other hand, the cooling water flowing in the low-pressure stage side motor cooling water passage 71 in the circumferential direction is supplied to the low-pressure stage side cooling water passage 17 by the coil side connecting portion 81 and flows in the circumferential direction. At this time, the low-pressure stage side air bearing 38 is cooled by the cooling water flowing inside the low-pressure stage side bearing housing 22.

### Modification Examples

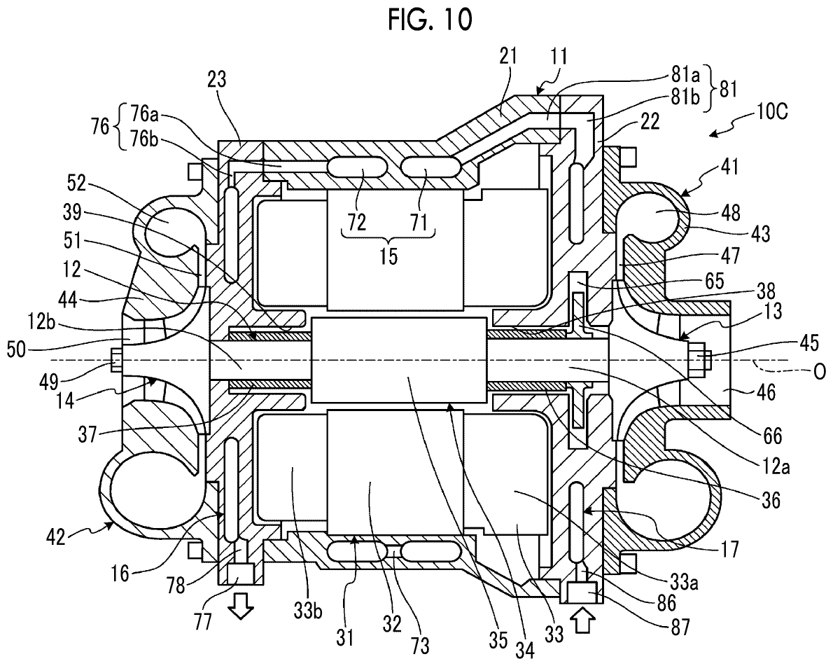

FIG. 10 is a vertical sectional view showing a modification example of the electric compressor of the third embodiment.

As shown in FIG. 10, an electric compressor 10C has substantially the same configuration as the electric compressor 10B of the third embodiment. That is, the housing 11, the rotary shaft 12, the low-pressure stage wheel 13, the high-pressure stage wheel 14, the motor cooling water passage 15, the high-pressure stage side cooling water passage 16, and the low-pressure stage side cooling water passage 17 are substantially the same as those of the third embodiment.

A difference from the electric compressor 10B of the third embodiment is that the low-pressure stage side motor cooling water passage 71 and the high-pressure stage side motor cooling water passage 72 communicate with each other, and the low-pressure stage side motor cooling water passage 71 and the high-pressure stage side motor cooling water passage 72 do not have the cooling water inlet portion 74. A cooling water inlet portion 87 is provided in the low-pressure stage side cooling water passage 17 via an inlet connecting portion 86.

The cooling water is supplied from the inlet connecting portion 86 on the low-pressure stage side to the low-pressure stage side cooling water passage 17 and flows in the circumferential direction. At this time, the low-pressure stage side air bearing 38 is cooled by the cooling water flowing inside the low-pressure stage side bearing housing 22. The cooling water is supplied from the coil side connecting portion 81 to the low-pressure stage side motor cooling water passage 71 and flows in the circumferential direction. In addition, the cooling water is supplied from the low-pressure stage side motor cooling water passage 71 to the high-pressure stage side motor cooling water passage 72 and flows in the circumferential direction. At this time, the stator 31 is cooled by the cooling water flowing inside the motor housing 21. Then, the cooling water is supplied from the high-pressure stage side motor cooling water passage 72 to the high-pressure stage side cooling water passage 16 and flows in the circumferential direction. At this time, the high-pressure stage side air bearing 39 is cooled by the cooling water flowing inside the high-pressure stage side bearing housing 23.

The cooling water inlet portion 87 is provided on the low-pressure stage side cooling water passage 17 side, and the cooling water outlet portion 77 is provided on the high-pressure stage side cooling water passage 16 side. However, the cooling water outlet portion 77 may be provided on the low-pressure stage side cooling water passage 17 side, and the cooling water inlet portion 87 may be provided on the high-pressure stage side cooling water passage 16 side.

### Fourth Embodiment

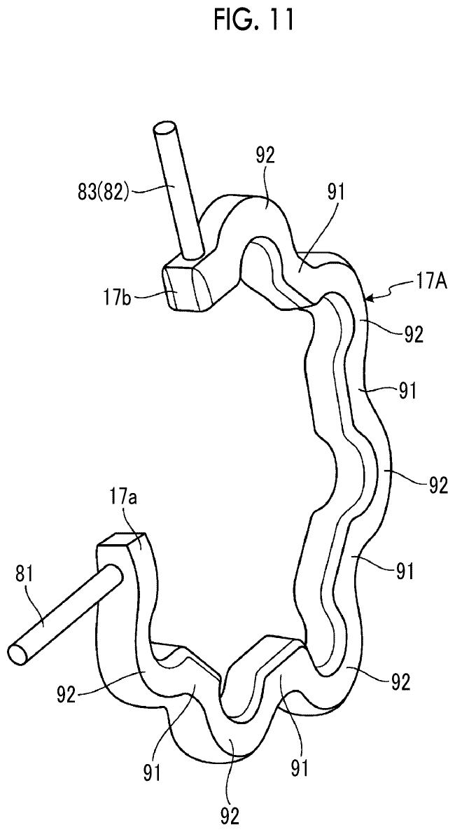

FIG. 11 is a perspective view schematically showing a high pressure wheel side cooling water passage in an electric compressor of a fourth embodiment. A basic configuration according to the present embodiment is substantially the same as that according to the above-described second embodiment, and description will be made with reference to FIG. 6. The same reference numerals will be given to members having functions the same as those according to the above-described second embodiment, and detailed description thereof will be omitted.

As shown in FIGS. 6 and 11, the electric compressor 10A includes the housing 11, the rotary shaft 12, the low-pressure stage wheel 13, the high-pressure stage wheel 14, the motor cooling water passage 15, and a low-pressure stage side cooling water passage 17A.

The low-pressure stage side cooling water passage 17A is continuously bent in the radial direction of the stator 31 in the circumferential direction. That is, the low-pressure stage side cooling water passage 17A has an arcuate portion 91 and a curved portion 92. The arcuate portion 91 and the curved portion 92 of the low-pressure stage side cooling water passage 17A are alternately provided in the circumferential direction, and are continuous in the circumferential direction. The arcuate portion 91 has a shape along an arc centered on the axial center O. The curved portion 92 has a shape that is curved while protruding outward in the radial direction with respect to an arc centered on the axial center O. Therefore, in the low-pressure stage side cooling water passage 17A, a plurality of arcuate portions 91 and a plurality of curved portions 92 are alternately connected to each other, and accordingly, the stator 31 has a shape that is continuously bent in the radial direction.

The low-pressure stage side cooling water passage 17A cools the low-pressure stage side bearing housing 22 by allowing the cooling water supplied from the coil side connecting portion 81 to flow. At this time, the cooling water flows while being bent in the low-pressure stage side cooling water passage 17A, and accordingly, a contact area between the cooling water and an inner surface of the low-pressure stage side cooling water passage 17A increases, and the cooling performance of the low-pressure stage side bearing housing 22 by the cooling water is improved.

In the present embodiment, the shape in which the low-pressure stage side cooling water passage 17A is bent continuously in the radial direction of the stator 31 in the circumferential direction is not limited to the above-described shape. For example, the low-pressure stage side cooling water passage 17A along the circumferential direction may have a shape in which the protrusions and the recesses are alternately repeated in the circumferential direction, or a shape in which the protrusions are provided only on the outer side in the radial direction, only on the inner side in the radial direction, or on both sides.

In addition, in the present embodiment, the wheel cooling water passage that continuously bends in the radial direction of the stator 31 in the circumferential direction is applied to the low-pressure stage side cooling water passage 17A. However, the present disclosure is not limited to this configuration. The wheel cooling water passage that is continuously bent in the radial direction of the stator 31 in the circumferential direction may be transferred to the high-pressure stage side cooling water passage 16 or the motor cooling water passage 15.

### Modification Example

The electric compressor 10, 10A, 10B, or 10C of each of the above-described embodiments is manufactured by casting the motor housing 21, the low-pressure stage side bearing housing 22, and the high-pressure stage side bearing housing 23 that configure the housing 11. In this case, it is preferable to adjust the surface roughness of the core for forming the motor cooling water passage 15 and the wheel side cooling water passages 16, 17, and 17A to roughen the surface roughness of the inner peripheral surfaces of the motor cooling water passage 15 and the wheel side cooling water passages 16, 17, and 17A. For example, it is preferable to set the surface roughness Ra in a range of 10 μm to 100 μm. The surface roughness of the inner peripheral surface of the motor cooling water passage 15 and the wheel side cooling water passages 16, 17, and 17A is set to the surface roughness Ra, and accordingly, a surface area is increased, the heat transfer performance can be improved, and the cooling performance of the low-pressure stage side air bearing 38 and the high-pressure stage side air bearing 39 by the cooling water can be improved.

### Effect of Action of Present Embodiment

According to a first aspect, there is provided an electric compressor including: a housing 11 having a stator 31 that has a cylindrical shape; a rotary shaft 12 that is disposed inside the housing 11 and that has a rotor 34 facing the stator 31; a low-pressure stage wheel 13 that is fixed to one side of the rotary shaft 12 in a shaft direction; a high-pressure stage wheel 14 that is fixed to the other side of the rotary shaft 12 in the shaft direction; a motor cooling water passage 15 that is provided on an outer side in a radial direction of the stator 31 in the housing 11; and a wheel side cooling water passages 16, 17, and 17A that are provided on at least one of the low-pressure stage wheel 13 side and the high-pressure stage wheel 14 side of the stator 31 in the housing 11.

According to the electric compressor according to the first aspect, the stator iron core 32 in the stator 31 can be cooled by the cooling water flowing through the motor cooling water passage 15, and the low-pressure stage side air bearing 38 and the high-pressure stage side air bearing 39 can be cooled by the cooling water flowing through the wheel side cooling water passages 16, 17, and 17A. Therefore, cooling performance can be improved.

In addition, since the low-pressure stage side air bearing 38 and the high-pressure stage side air bearing 39 are efficiently cooled by the cooling water, insufficient cooling of the stator 31 and the rotor 34 can be suppressed by supplying a large amount of the compressed air to the stator 31 and the rotor 34. In the related art, a portion of the compressed air supplied to the low-pressure stage side air bearing 38 and the high-pressure stage side air bearing 39 is supplied to the stator 31 or the rotor 34 for cooling. However, the low-pressure stage side air bearing 38 and the high-pressure stage side air bearing 39 are efficiently cooled by the cooling water flowing through the motor cooling water passage 15 or the wheel side cooling water passages 16, 17, and 17A. Therefore, the flow rate of the compressed air for cooling the low-pressure stage side air bearing 38 and the high-pressure stage side air bearing 39 can be reduced. Therefore, the air shortage in the stator 31 and the rotor 34 can be suppressed, and the stator 31 and the rotor 34 can be appropriately cooled.

In the electric compressor according to a second aspect, the motor cooling water passage 15 and the wheel side cooling water passages 16, 17, and 17A are connected to each other by coil side connecting portions 76 and 81 extending along a shaft direction of the stator 31. Accordingly, the cooling water can be appropriately caused to flow between the motor cooling water passage 15, the coil side connecting portions 76 and 81, and the wheel side cooling water passages 16, 17, and 17A, and high cooling performance can be ensured. In addition, a passage length of the cooling water can be shortened, and a pressure loss of the cooling water can be reduced.

In the electric compressor according to a third aspect, the wheel side cooling water passages 16, 17, and 17A are provided discontinuously along a circumferential direction of the stator 31, one end side in the circumferential direction is connected to the coil side connecting portions 76 and 81, and the other end side in the circumferential direction is connected to a cooling water inlet portion 74 or cooling water outlet portions 77 and 82. Accordingly, the cooling water can be appropriately caused to flow along the circumferential direction of the wheel side cooling water passages 16, 17, and 17A, and high cooling performance can be ensured.

In the electric compressor according to a fourth aspect, the cooling water inlet portion 7 is provided in any one of the motor cooling water passage 15 and the wheel side cooling water passages 16, 17, and 17A, and the cooling water outlet portions 77 and 82 are provided in the other of the motor cooling water passage 15 and the wheel side cooling water passages 16, 17, and 17A. Accordingly, the cooling water can be appropriately caused to flow between the motor cooling water passage 15 and the wheel side cooling water passages 16, 17, and 17A, and high cooling performance can be ensured.

In the electric compressor according to a fifth aspect, low-pressure stage side cooling water passages 17 and 17A provided on the low-pressure stage wheel 13 side of the stator 31 in the housing 11, and a high-pressure stage side cooling water passage 16 provided on the high-pressure stage wheel 14 side of the stator 31 are provided. Accordingly, the low-pressure stage side air bearing 38 can be cooled by the cooling water flowing through the low-pressure stage side cooling water passages 17 and 17A, and the high-pressure stage side air bearing 39 can be cooled by the cooling water flowing through the high-pressure stage side cooling water passage 16.

In the electric compressor according to a sixth aspect, a low-pressure stage side motor cooling water passage 71 and a high-pressure stage side motor cooling water passage 72 are provided at intervals in a shaft direction of the stator 31, and the low-pressure stage side motor cooling water passage 71 and the high-pressure stage side motor cooling water passage 72 are discontinuous in a circumferential direction of the stator 31 and communicate with each other via a motor side connecting portion 73. Accordingly, the cooling water can be appropriately caused to flow through the low-pressure stage side motor cooling water passage 71, the motor side connecting portion 73, and the high-pressure stage side motor cooling water passage 72.

In the electric compressor according to a seventh aspect, a low-pressure stage side motor cooling water passage 71 and a high-pressure stage side motor cooling water passage 72 that are provided at intervals in a shaft direction of the stator 31 are provided, the low-pressure stage side motor cooling water passage 71 and the high-pressure stage side motor cooling water passage 72 are discontinuous in a circumferential direction of the stator 31 and communicate with each other via a motor side connecting portion 73, the low-pressure stage side motor cooling water passage 71 is connected to the low-pressure stage side cooling water passages 17 and 17A by a coil side connecting portion 81, and the high-pressure stage side motor cooling water passage 72 is connected to the high-pressure stage side cooling water passage 16 by a coil side connecting portion 76. Accordingly, the cooling water of the low-pressure stage side motor cooling water passage 71 can be appropriately flowed to the low-pressure stage side cooling water passages 17 and 17A, and the cooling water of the high-pressure stage side motor cooling water passage 72 can be appropriately flowed to the high-pressure stage side cooling water passage 16.

In the electric compressor according to an eighth aspect, a passage area of the low-pressure stage side cooling water passage 17 varies in a circumferential direction (flow circumferential direction of the cooling water). Accordingly, the contact area between the cooling water and the inner surface of the low-pressure stage side cooling water passage 17 can be increased, and thus the cooling performance of the housing 11 by the cooling water can be improved. For example, by alternately providing the protrusion 84 that protrudes outward in the radial direction and the recess 85 that is recessed inward in the radial direction in the low-pressure stage side cooling water passage 17 in the circumferential direction, a region through which a bolt (not shown) that fastens the motor housing 21 and the low-pressure stage side bearing housing 22 is inserted can be ensured by the recess 85.

In the electric compressor according to a ninth aspect, the low-pressure stage side cooling water passage 17A has a shape that continuously bends in the radial direction of the stator 31 in a circumferential direction (flow circumferential direction of the cooling water). Accordingly, the contact area between the cooling water and the inner surface of the low-pressure stage side cooling water passage 17A can be increased, and thus the cooling performance of the housing 11 by the cooling water can be improved.

In the electric compressor according to a tenth aspect, the motor cooling water passage 15 and the wheel side cooling water passages 16, 17, and 17A are set in a range of 10 μm to 100 μm in surface roughness Ra of an inner peripheral surface. Accordingly, the surface area of the motor cooling water passage 15 and the wheel side cooling water passages 16, 17, and 17A is increased, the heat transfer performance can be improved, and the cooling performance of the low-pressure stage side air bearing 38 and the high-pressure stage side air bearing 39 by the cooling water can be improved.

The electric compressor according to an eleventh aspect further includes air passages 61 and 62 that supply cooling air to at least the stator 31, and the wheel side cooling water passages 16, 17, and 17A cool air bearings 38 and 39 that rotatably support the rotary shaft 12 with respect to the housing 11. Accordingly, since the low-pressure stage side air bearing 38 and the high-pressure stage side air bearing 39 are efficiently cooled by the cooling water, the flow rate of the compressed air for cooling the stator 31 can be increased.

In the above-described embodiment, the low-pressure stage side motor cooling water passage 71 and the high-pressure stage side motor cooling water passage 72 are provided as the motor cooling water passage 15. However, the present disclosure is not limited to this configuration. For example, one or three or more motor cooling water passages 15 may be provided. In addition, the low-pressure stage side motor cooling water passage 71 and the high-pressure stage side motor cooling water passage 72 are made discontinuous in the circumferential direction, but may have a shape continuous in the circumferential direction.

In addition, in the above-described embodiment, the motor side connecting portion 73 is provided in the motor housing 21, and the coil side connecting portions 76 and 81 are provided in the bearing housings 22 and 23. However, the present disclosure is not limited to this configuration. For example, the motor side connecting portion 73 and the coil side connecting portions 76 and 81 may be provided as separate pipes from the motor housing 21 or the bearing housings 22 and 23, may be disposed on the outer side of the housing 11, and may be connected to the motor cooling water passage 15 or the wheel side cooling water passages 16, 17, and 17A.

In addition, in the above-described embodiment, the first air passage 61 is provided in the low-pressure stage side bearing housing 22, and the second air passage 62 is provided in the motor housing 21 and the high-pressure stage side bearing housing 23. However, the present disclosure is not limited to this configuration. The first air passage 61 may be provided in the high-pressure stage side bearing housing 23, and the second air passage 62 may be provided in the motor housing 21 and the low-pressure stage side bearing housing 22.

### REFERENCE SIGNS LIST

10, 10A, 10B, 10C Electric compressor
11 Housing
12 Rotary shaft
12a Low-pressure stage side shaft portion
12b High-pressure stage side shaft portion
13 Low-pressure stage wheel
14 High-pressure stage wheel
15 Motor cooling water passage
16 High-pressure stage side cooling water passage (wheel side cooling water passage)
17, 17A Low-pressure stage side cooling water passage (wheel side cooling water passage)
21 Motor housing
22 Low-pressure stage side bearing housing
23 High-pressure stage side bearing housing
31 Stator
32 Stator iron core
33 Stator coil
33a Low-pressure stage side coil end
33b High-pressure stage side coil end
34 Rotor
35 Rotor iron core
36 Low-pressure stage side bearing sleeve
37 High-pressure stage side bearing sleeve
38 Low-pressure stage side air bearing
39 High-pressure stage side air bearing
41 Low-pressure compressor
42 High-pressure compressor
43 Low-pressure stage side housing
44 High-pressure stage side housing
45, 49 Bolt
46, 50 Intake port
47, 51 Diffuser
48, 52 Scroll part
53 Connection passage
61 First air passage
62 Second air passage
63 Air intake port
64 Air bleeding passage
65 Low-pressure stage side space portion
66 Thrust disk
67 Shaft direction air passage
68 Radial direction air passage
71 Low-pressure stage side motor cooling water passage
72 High-pressure stage side motor cooling water passage
73 Motor side connecting portion
74 Cooling water inlet portion
75 Inlet connecting portion
76 Coil side connecting portion (low-pressure coil side connecting portion)
77 Cooling water outlet portion
78 Outlet connecting portion
81 Coil side connecting portion (high-pressure coil side connecting portion)
82 Cooling water outlet portion
83 Outlet connecting portion
84 Protrusion
85 Recess
86 Inlet connecting portion
87 Cooling water inlet portion
91 Arcuate portion
92 Curved portion

1. An electric compressor comprising:
a housing having a stator that has a cylindrical shape;
a rotary shaft that is disposed inside the housing and that has a rotor facing the stator;
a low-pressure stage wheel that is fixed to one side of the rotary shaft in a shaft direction;
a high-pressure stage wheel that is fixed to the other side of the rotary shaft in the shaft direction;
a motor cooling water passage that is provided on an outer side in a radial direction of the stator in the housing; and
a wheel side cooling water passage that is provided on at least one of the low-pressure stage side and the high-pressure stage side of the stator in the housing.

2. The electric compressor according to claim 1, wherein
the motor cooling water passage and the wheel side cooling water passage are connected to each other by a coil side connecting portion extending along a shaft direction of the stator.

3. The electric compressor according to claim 2, wherein
the wheel side cooling water passage is provided discontinuously along a circumferential direction of the stator, one end side of the wheel side cooling water passage in the circumferential direction is connected to the coil side connecting portion, and the other end side of the wheel side cooling water passage in the circumferential direction is connected to a cooling water inlet portion or a cooling water outlet portion.

4. The electric compressor according to claim 3, wherein
the cooling water inlet portion is provided in any one of the motor cooling water passage and the wheel side cooling water passage, and the cooling water outlet portion is provided in the other of the motor cooling water passage and the wheel side cooling water passage.

5. The electric compressor according to claim 1, wherein
the wheel side cooling water passage includes a low-pressure stage side cooling water passage provided on the low-pressure stage side of the stator in the housing, and a high-pressure stage side cooling water passage provided on the high-pressure stage side of the stator.

6. The electric compressor according to claim 1, wherein
the motor cooling water passage has a low-pressure stage side motor cooling water passage and a high-pressure stage side motor cooling water passage that are provided at intervals in a shaft direction of the stator, and the low-pressure stage side motor cooling water passage and the high-pressure stage side motor cooling water passage are discontinuous in a circumferential direction of the stator and communicate with each other via a motor side connecting portion.

7. The electric compressor according to claim 5, wherein
the motor cooling water passage has a low-pressure stage side motor cooling water passage and a high-pressure stage side motor cooling water passage that are provided at intervals in a shaft direction of the stator, the low-pressure stage side motor cooling water passage and the high-pressure stage side motor cooling water passage are discontinuous in a circumferential direction of the stator and communicate with each other via a motor side connecting portion, the low-pressure stage side motor cooling water passage is connected to the low-pressure stage side cooling water passage by a low-pressure coil side connecting portion, and the high-pressure stage side motor cooling water passage is connected to the high-pressure stage side cooling water passage by a high-pressure coil side connecting portion.

8. The electric compressor according to claim 1, wherein
a passage area of the wheel side cooling water passage varies in a flow circumferential direction of the cooling water.

9. The electric compressor according to claim 1, wherein
the wheel side cooling water passage continuously bends in the radial direction of the stator in a flow circumferential direction of the cooling water.

10. The electric compressor according to claim 1, wherein
the motor cooling water passage and the wheel side cooling water passage are set in a range of 10 μm to 100 μm in surface roughness Ra of an inner peripheral surface.

11. The electric compressor according to claim 1, further comprising:
an air passage that supplies cooling air to at least the stator, wherein
the wheel side cooling water passage cools an air bearing that rotatably supports the rotary shaft with respect to the housing.

12. The electric compressor according to claim 2, wherein
the wheel side cooling water passage includes a low-pressure stage side cooling water passage provided on the low-pressure stage side of the stator in the housing, and a high-pressure stage side cooling water passage provided on the high-pressure stage side of the stator.

13. The electric compressor according to claim 3, wherein
the wheel side cooling water passage includes a low-pressure stage side cooling water passage provided on the low-pressure stage side of the stator in the housing, and a high-pressure stage side cooling water passage provided on the high-pressure stage side of the stator.

14. The electric compressor according to claim 4, wherein
the wheel side cooling water passage includes a low-pressure stage side cooling water passage provided on the low-pressure stage side of the stator in the housing, and a high-pressure stage side cooling water passage provided on the high-pressure stage side of the stator.

15. The electric compressor according to claim 2, wherein
the motor cooling water passage has a low-pressure stage side motor cooling water passage and a high-pressure stage side motor cooling water passage that are provided at intervals in a shaft direction of the stator, and the low-pressure stage side motor cooling water passage and the high-pressure stage side motor cooling water passage are discontinuous in a circumferential direction of the stator and communicate with each other via a motor side connecting portion.

16. The electric compressor according to claim 3, wherein
the motor cooling water passage has a low-pressure stage side motor cooling water passage and a high-pressure stage side motor cooling water passage that are provided at intervals in a shaft direction of the stator, and the low-pressure stage side motor cooling water passage and the high-pressure stage side motor cooling water passage are discontinuous in a circumferential direction of the stator and communicate with each other via a motor side connecting portion.

17. The electric compressor according to claim 4, wherein
the motor cooling water passage has a low-pressure stage side motor cooling water passage and a high-pressure stage side motor cooling water passage that are provided at intervals in a shaft direction of the stator, and the low-pressure stage side motor cooling water passage and the high-pressure stage side motor cooling water passage are discontinuous in a circumferential direction of the stator and communicate with each other via a motor side connecting portion.

18. The electric compressor according to claim 5, wherein
the motor cooling water passage has a low-pressure stage side motor cooling water passage and a high-pressure stage side motor cooling water passage that are provided at intervals in a shaft direction of the stator, and the low-pressure stage side motor cooling water passage and the high-pressure stage side motor cooling water passage are discontinuous in a circumferential direction of the stator and communicate with each other via a motor side connecting portion.

19. The electric compressor according to claim 2, wherein
a passage area of the wheel side cooling water passage varies in a flow circumferential direction of the cooling water.

20. The electric compressor according to claim 3, wherein
a passage area of the wheel side cooling water passage varies in a flow circumferential direction of the cooling water.
